(19) United States
(12) Patent Application Publication
(10) Pub. No.: US 2013/0228394 A1
(43) Pub. Date: Sep. 5, 2013

(54) Worker Safety Device and Method

(71) Applicant: SOUSA TRUCK TRAILER REPAIR LTD., Mississauga (CA)

(72) Inventors: John Sousa, Caledon Village (CA); Markus Hess, Thornhill (CA); Cameron Dougall, Orillia (CA)

(73) Assignee: Sousa Truck Trailer Repair Ltd., Mississauga (CA)

(21) Appl. No.: 13/779,971

(22) Filed: Feb. 28, 2013

(30) Foreign Application Priority Data
Mar. 1, 2012 (CA) 2770294

(51) Int. Cl. A62B 35/00; E04G 21/32

(52) U.S. Cl. CPC A62B 35/0068; E04G 21/3204
USPC 182/3; 248/231.41

(57) ABSTRACT

A worker safety device for use with an object having a person support surface, the device comprising: a length-adjustable device frame positionable on said object; a frame fastener coupled to the device frame configured to detachably fasten the device frame to the object; an attachment means, attached to the device frame, configured and positioned to attach a personal fall-prevention device to the device frame; whereby a person on said surface using the fall-prevention device can prevent a fall from said surface by attaching the fall-prevention device to the attachment means.

### FIELD OF THE INVENTION

This invention relates to the field of worker safety, and in particular, the field of devices and methods for improving worker safety.

### BACKGROUND OF THE INVENTION

In recent years, governments, businesses, and society at large have placed a progressively greater value on worker safety. Injuries to workers can be devastating to the injured workers themselves, their families, and their communities. The costs to businesses and governments associated with such injuries are also substantial. Such costs include the costs to businesses of insuring against the risk of liability for worker injuries. Meanwhile, it is usually government, and ultimately the taxpaying public, that bears the costs of caring for injured workers, particularly those that have suffered severe or catastrophic injury. For these and other reasons, businesses, governments and workers themselves striving to improve safety, including the optimization of work processes and methods, and the use of the most advanced safety-promoting equipment available.

Tractor-trailers (also known as truck-and-trailer, or semi-trailer trucks) are a common sight on North American highways. A tractor-trailer consists of a towing engine (“tractor”), and a trailer that carries freight. The trailer (also referred to as a “truck trailer” is attached to the tractor at the tractor's rear end, so that some fraction of the weight of the trailer is held up by the tractor, while the rest of the weight rests on the trailer's own wheels.

From time to time, it is necessary to perform repairs or routine maintenance on these trailers, requiring a repair person to climb onto the roof of the trailer. Climbing onto and working on the roof creates a safety hazard, namely, the risk that the worker will fall off of the roof and suffer injury or death.

### SUMMARY OF THE INVENTION

Therefore, according to the present invention, there is provided a worker safety device for use with an object having a person support surface, the device comprising a length-adjustable device frame positionable on said object; a frame fastener coupled to the device frame configured to detachably fasten the device frame to the object; an attachment means, attached to the device frame, configured and positioned to attach a personal fall-prevention device to the device frame; whereby a person on said surface using the fall-prevention device can prevent a fall from said surface by attaching the fall-prevention device to the attachment means.

According to another aspect of the invention, there is provided a method of preventing a worker from falling off of a roof of a truck trailer, the trailer having first and second side rails, the method comprising the steps of: providing a worker safety device including a length-adjustable device frame, a first frame fastening element at a first end of the device frame, and a second frame fastening element at a second end of the device frame; fastening the frame to the trailer by (1) positioning the device frame in a pre-fastening position and (2) actuating a frame fastener to cause the frame fastening elements to fasten the device frame to the side rails; and attaching fall-preventing worker safety gear to the device to prevent a worker from falling.

### BRIEF DESCRIPTION OF THE DRAWINGS

Reference will now be made, by way of example only, to preferred embodiments of the invention and in which:

FIG. 1 is a perspective view of a worker safety device according to the present invention.

FIG. 2 is a top view of a worker safety device according to the present invention.

FIG. 3 is a side view worker safety device according to the present invention, with the device fastened to an object.

FIG. 4 is a close-up perspective view of a fastening element according to the present invention.

FIG. 5 is a close-up cross-sectional view of a portion of the device, including a frame fastener according to the present invention.

FIG. 6 is a perspective view of an alternative worker safety device according to the present invention.

FIG. 7 is an end schematic view of a truck trailer.

FIG. 8 is a side view of an alternative lateral movement facilitating means.

FIG. 9 is a perspective view of an alternative worker safety device according to the present invention.

### DETAILED DESCRIPTION OF THE PREFERRED EMBODIMENTS

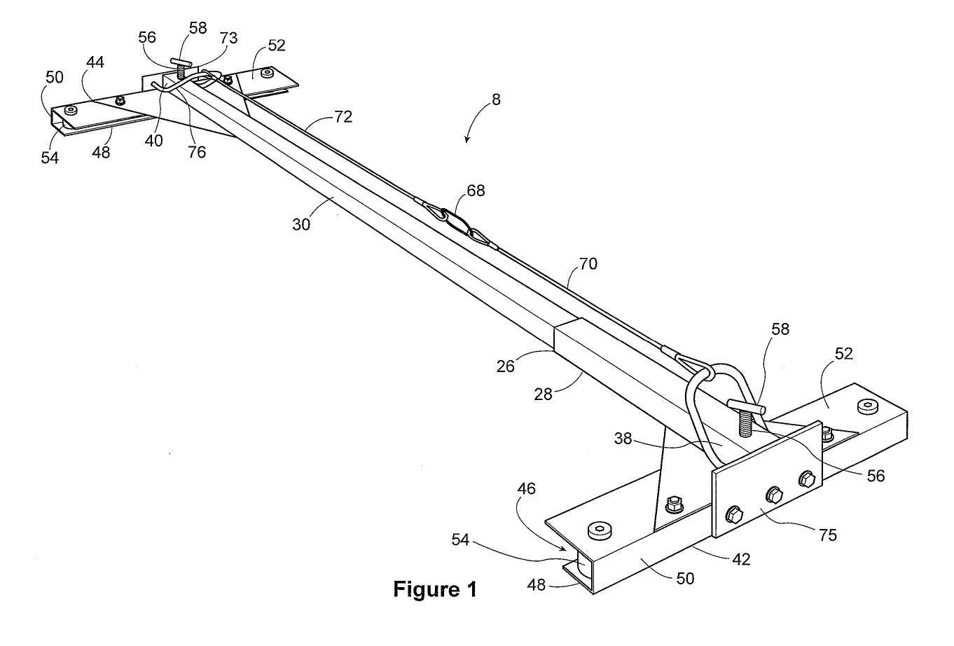

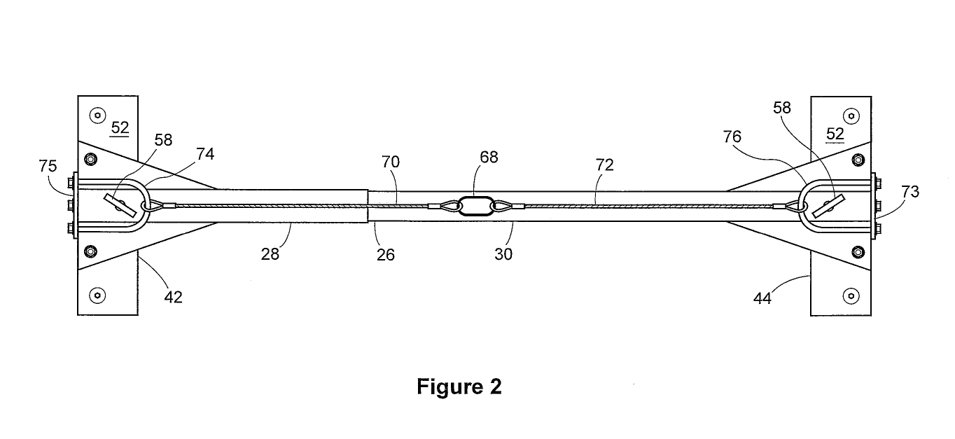

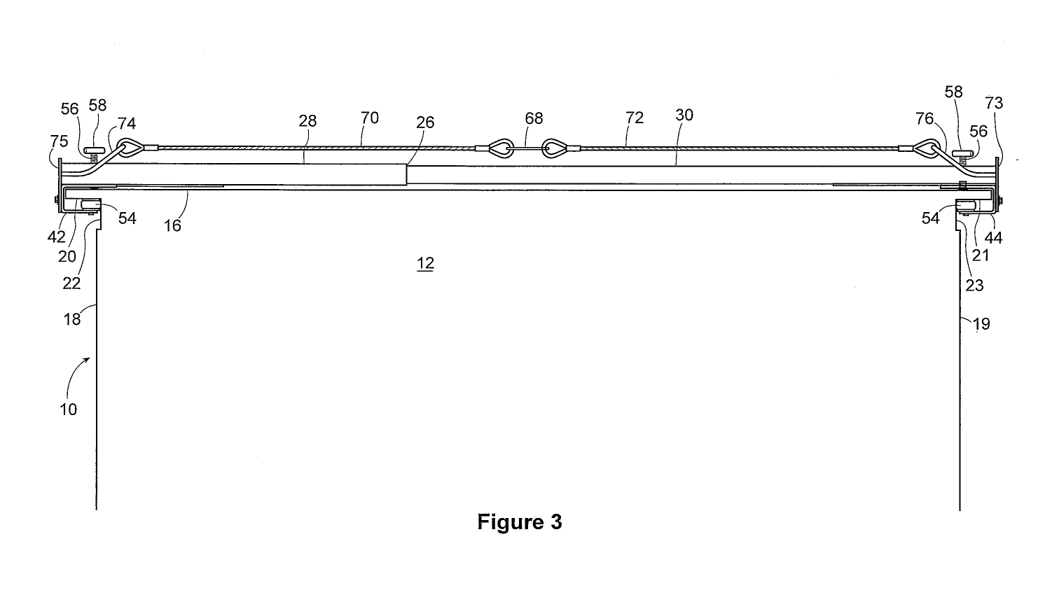

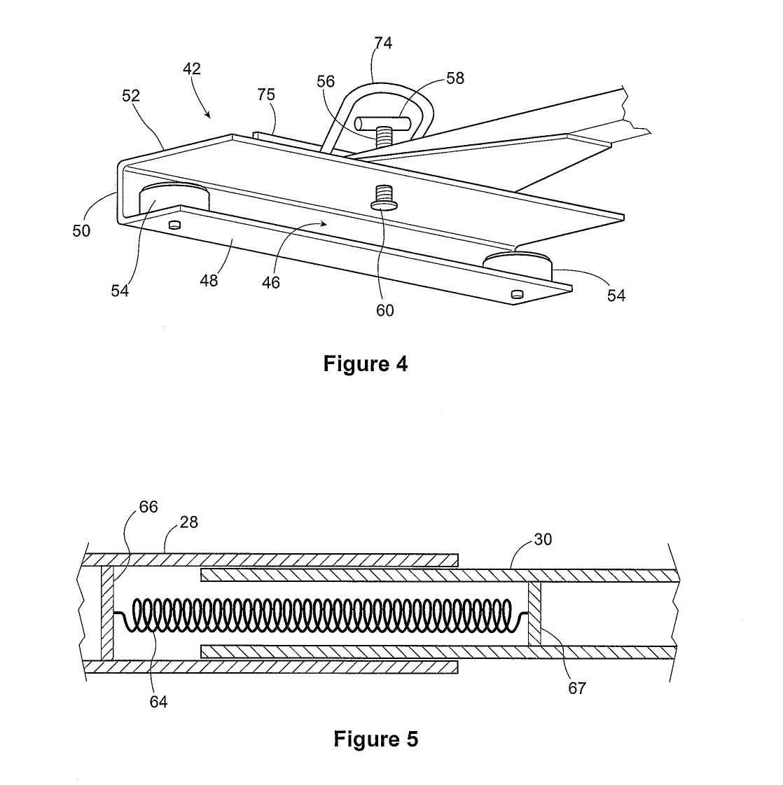

Referring now to FIGS. 1-3, the worker safety device 8 is shown. As shown in FIG. 3, the device 8 is preferably positioned on an object, typically a truck trailer 10. Trailer 10 comprises trailer body 12, supported by trailer wheels (not shown). Trailer 10 further comprises roof 16, and sides, preferably in the form of first and second side walls 18, 19. At the intersection between roof 16 and each side wall 18, 19 is a side edge of roof 16. Typically, at each of the two side edges of roof 16, there is a roof rail (20, 21) running along substantially the entire length of the trailer body 12, from the back of the trailer to the front. Also on the side walls of the typical trailer body 12, adjacent to each rail 20, is a rail indentation (22, 23), generally located immediately below rail 20. Some trailers have no such indentation, but commonly, the rail 20 protrudes outward beyond the portion of the wall (18, 19) immediately adjacent to rail 20, providing a geometry that facilitates the fastening of the device 8 to the rails 20, 21.

It will be appreciated that the invention may be used on a variety of objects, including, without limitation straight trucks.

An embodiment of the worker safety device 8 is shown at FIGS. 1-3. The device 8 comprises a length adjustable device frame 26 positionable on the object, typically the trailer 10. It will be appreciated, as elaborated below, that the worker safety device 8 is preferably configured for use with an object, such as trailer 10, that has a person-support surface on which a worker might be located. In the case of truck trailer 10, that person-support surface would typically comprise roof 16, but it will be appreciated that a device in accordance with the present invention may be used with other objects where it is desired to protect worker safety.

As shown in FIG. 3, the device frame 26 is preferably positioned above the roof 16, with the sides 22, 23 of the trailer 10 extending downward from the roof 16.

In the embodiment shown in FIGS. 1-3, the frame 26 comprises a first elongate member 28 and a second elongate member 30. The members 28, 30 are preferably attached to one another, and are slidably and axially moveable relative to one another. Most preferably, members 28, 30 are configured and positioned in telescopic relation to one another. Thus, the length of the frame 26 is increased by the first elongate member 28 and second elongate member 30 coming apart (preferably like lengthening a telescope), and decreased by their coming together (preferably like shortening a telescope). First elongate member 28 has a hollow central channel in which second elongate member 30 is positioned. It will be appreciated that other possible configurations for the device frame 26 are comprehended by the invention. For example, the frame 26 could comprise two pieces mounted side by side in axial sliding relation. Or, member 28 could be positioned in member 30. What is important is that the device or frame, in the preferred embodiment, be length-adjustable to permit the device 8 to be fastened to the object as described below.

The device 8 further comprises a frame fastener, coupled to device frame 26, and configured to detachably fasten the frame 26 to the trailer body 12.

Referring to FIG. 5, the preferred frame fastener comprises a coil spring 64, attached to a first spring attachment element 66 that is fixed to member 28, and a second spring attachment element 67 that is fixed to member 30. The preferred frame fastener works by means of spring 64 configured to pull members 28, 30 together. In the process of fastening the frame 26 to the trailer 10, fastening elements 42, 44 (described in further detail below) are pulled against the side edges of the trailer, so as to grip rails 20, 21, and preferably engage indentations 22, 23. The frame 26 is thus fastened to trailer 10. To detach the frame 26, members 28, 30 and elements 42, 44 are pulled apart against the force of spring 64, thus releasing the grip of one or both of elements 42, 44 on the corresponding rail 20, 21.

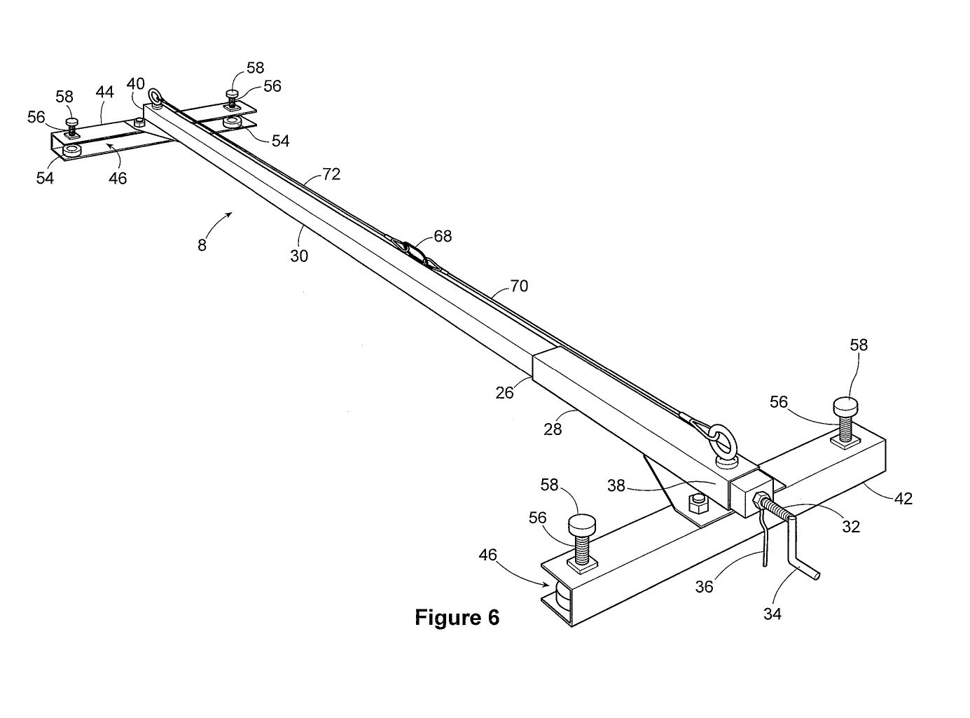

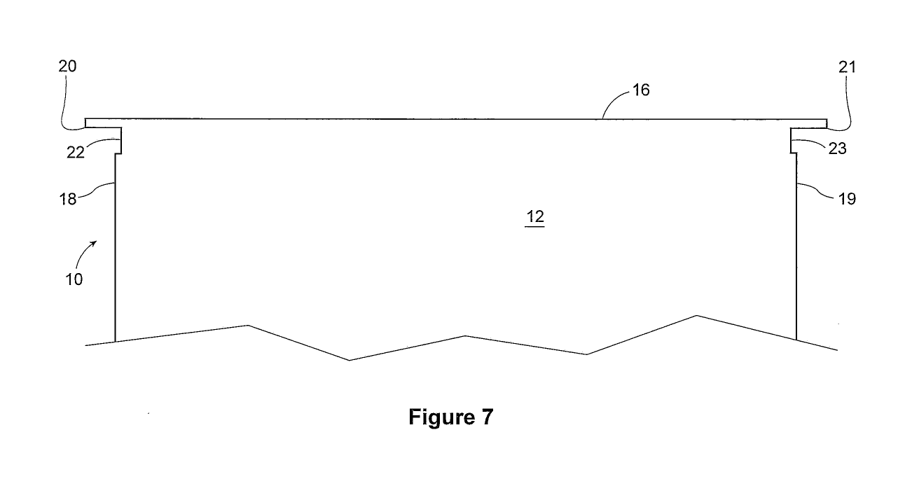

In an alternate embodiment (see FIG. 6), the frame fastener comprises a rotatable threaded shaft 32, having handle 34 attached thereto and configured to turn the shaft 32. The alternate frame fastener further comprises lock 36, which is preferably positioned on shaft 32 to lock shaft 32. When lock 36 is actuated, shaft 32 is locked from rotating relative to frame 26. Thus, when shaft 32 is rotated, using handle 34 to fasten frame 26 to the trailer body 12, lock 36 is then actuated to prevent frame 36 from becoming unfastened. In this alternate embodiment, the fastening is accomplished by the fastening elements 42, 44 gripping the rails 20, 21 and indentations 22, 23, as explained elsewhere.

To adjust the length of frame 26 in this alternate embodiment, the threaded shaft 32 may be rotated. Preferably, the shaft 32 is threadably coupled to, and axially moveable relative to, the first frame element 28, and attached to the second frame element 28. Thus, when the shaft 32 is turned so as to move further into frame element 28, second frame element 30 is pushed out of first frame element 28, thus extending the length of frame 26. By contrast, when shaft 32 is rotated so as to extend further out of first frame element 28, second frame element 30 is pulled further into first frame element 28, thus reducing the length of frame 26. Thus, by coupling shaft 32 to frame elements 28, 30, the length of frame 26 can be adjusted.

It will be appreciated that apart from the preferred and alternate embodiments described herein, the invention comprehends other modes of frame fastener. What is important is that the fastener be configured to fasten the device frame to the object. Thus, for example, anything that functions to hold the frame 26 in place on the object could be a frame fastener. Preferably, though not necessarily, the device frame will be detachably fastened to the object, meaning that the frame fastener is selectively operable to fasten the frame to the object and detach the frame from the object. A further example of such a frame fastener would be selectively engageable and disengageable suction cups attached to the frame, configured to fasten the frame to the object when engaged, and detach the frame when disengaged.

It will be appreciated that the fastening may be accomplished by means other than the gripping of rails 20, 21. For example, other parts of trailer 10 may be gripped. Or, a mode of fastening other than gripping may be employed. What is important is that the frame fastener be configured to fasten frame 26 to the object.

The elongate frame 26 preferably includes two opposed ends, comprising first end 38 and second end 40. Preferably, the frame fastener further includes a first fastening element 42 at end 38, and a second fastening element 44 at end 40. Preferably, each fastening element is shaped and positioned so as to define a chamber 46 sized, shaped and positioned to receive the rail (20, 21). The chamber 46 may be formed within each fastening element by means of bottom wall 48, end wall 50, and top wall 52, which define the chamber 46. The fastening elements 42, 44 are thus configured to cooperate with spring 64 to fasten frame 26 to trailer 10.

Preferably, the device 8 includes two wheel means attached to the device frame 26 and positioned so as to bear on sides 18, 19, so that the wheel means roll along the sides to facilitate movement of the device along the object. In the preferred embodiment, there is a wheel means associated with each of the fastening elements 42, 44, with each wheel means consisting of two wheels 54. Preferably, wheel means 54 are positioned in chamber 46, and rotatably attached to bottom wall 48 of each fastening element (42, 44). As can be seen in FIG. 3, wheels 54 are positioned so as to bear on respective sides 18, 19, and particularly, rails 20, 21.

Further included in device 8 is a lateral movement lock means. In the preferred embodiment, the lateral movement lock means comprises lock bolts 56. As shown in FIG. 1, there may be one lock bolt positioned on and rotatably attached to each top wall 52. Each bolt 56 comprises a head 58 configured to facilitate the rotation, by hand, of lock bolt 56. Each bolt 56 further preferably comprises a pressure lock pad 60. It will be appreciated that when the bolts 56 are turned in a locking direction, pads 60 move downward and press against the top side of rails 20, 21. When the lock bolts are in such locking position, they prevent the device 8 from being moved laterally along the length of the trailer, and along the length of rails 20, 21. To allow for such lateral movement, bolts 56 are turned in an unlocking direction, such that pads 60 come away from rails 20, 21, with the result that the device 8 can be pulled along the length of the trailer body 12.

It will be appreciated by those skilled in the art that the invention comprehends two types of locking, or fastening. First, the invention comprehends the use of the frame fastener to fasten the device frame 26 to the trailer body 12. The purpose of such fastening is to allow a person working on roof 16 to attach worker safety gear to the device 8 to prevent falling and injury. However, even with the frame 26 fastened to trailer body 12 by the frame fastener, it is still possible to move the device frame 26 along the length of trailer 12. This lengthwise or lateral movement along trailer 12 is important because it may be necessary for a worker to perform maintenance on one portion of the trailer, and then move safely to a different portion of the trailer and perform more maintenance there. Thus, in accordance with the present invention, a worker may fasten the device frame to trailer body 12 and perform work in the vicinity of the trailer adjacent to device frame 26. When it is desired to perform maintenance on a different portion of trailer body 12, bolts 56 may be unlocked, and the worker can push or pull device frame 26 along the length of trailer body 12 while the device frame 26 remains fastened to trailer body 12. This provides safety to the worker even as the worker moves the device frame 26. Then, when the worker reaches the portion of the trailer where further maintenance is to be performed, he can lock lock bolts 56, thus preventing lateral movement of device frame 26 along the length of trailer body 12 as he does his work.

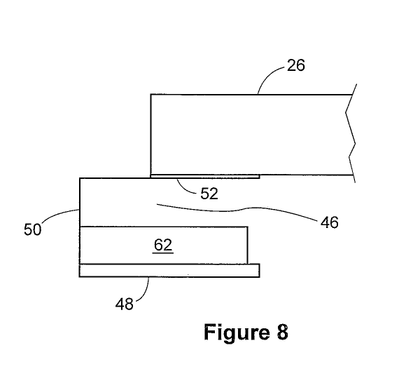

It will be appreciated that the invention comprehends other means for facilitating lateral movement of the device frame 26 along trailer body 12 besides the wheel means referred to above. For example, as shown in FIG. 8, the lateral movement facilitating means may include low friction sliders, consisting of low friction pads 62, positioned within chamber 46 of each fastening element 42, 44. Pads 62 are preferably made of a low-friction material, and like the wheel means, are positioned so as to bear against sides 18, 19, and in particular indentations 22, 23. Whatever form the means for facilitating lateral movement may take, it will be appreciated that such means preferably include a low-friction interface between device frame 26 (preferably fastening elements 42, 44), and the trailer body 12, to allow for easy lateral movement of the device frame 26 along the trailer body 12.

On the other hand, it will be appreciated that while the capability for such lateral movement is preferred to permit movement for maintenance, repair, snow removal etc., and while having means for facilitating such lateral movement is preferred, the invention does not require the capability for such lateral movement. Rather, though not preferred, it is possible for a user to simply unfasten or detach the device 8 from the trailer body 12 when it is desired to move the device 8 along the length of the trailer body 12.

The device 8 further preferably includes an attachment means, attached to the device frame 26, configured and positioned to attach a personal fall-prevention device for the frame 26. As a result, a person on roof 16 using the fall-prevention device can prevent a fall by attaching the fall-prevention device to the attachment means.

It will be appreciated that it is typical for fall-prevention safety equipment to include some kind of hook or carabiner which is meant to be attached to a fixed point to prevent a worker from falling. Therefore, the attachment means preferably comprises a hook-receiving element, most preferably in the form of ring 68. Preferably, as can be seen in FIGS. 1-3, the ring 68 is attached to both element 28 and element 30 adjacent to opposed ends 38 and 40 of the frame 26. This form of attachment is achieved, in the preferred embodiment, by means of cables 70, 72, which both attach ring 68 to fixed U-bolts 74, 76, which are fixed to elements 28 and 30 respectively by means of plates 73, 75, adjacent opposed ends 38, 40 respectively.

It will be appreciated that the attachment means may take other forms. It may be curved, and may have an open or closed shape. What is important is to provide a means for attaching a fall prevention device.

To use the device 8, a worker would fasten the device 8 to the trailer body 12. In the preferred embodiment, the worker climbing up to the roof 16 is initially positioned at one side of trailer 10. The worker positions device 8 in a pre-fastening position above roof 16. Preferably, the worker extends it across roof 16 so that the opposite end of device 8 (the opposite fastening element) grips the opposite rail. Then, the worker pulls the near side of the device 8, extending spring 64 and extending frame 26, so that the near fastening element is positioned off roof 16. The adjacent fastening element is then gently released and spring 64 contracts to cause the near fastening element to grip the near rail. The device 8 and frame 26 are thus fastened to the trailer 10 by actuating spring 64 to cause the fastening elements to fasten frame 26 to the side rails. Frame 26 can be removed or detached by pulling the near fastening element away from the opposite one against spring 64, releasing the near fastening element from gripping the near rail and then removing the device 8 from roof 16.

In the alternate embodiment of the frame fastener described above, the frame 26 would be lengthened so that fastening elements 42, 44 are wider apart that the width of roof 16 in the pre-fastening position. Shaft 32 is then rotated to bring elements 42, 44 together to fasten frame 26 to rails 20, 21.

It will be appreciated that the invention comprehends other modes of actuating the frame fastener to cause the fastening elements to fasten frame 26 to the side rails. For example, a strap connecting the frame elements may be retracted to pull the fastening elements together to fasten the frame 26 to rails 20, 21.

After fastening, the worker would attach a fall-prevention device or safety harness, to which he himself is attached, to ring 68, which is fixed via cables 70, 72 and fix U-bolts 74,76 to frame 26. Then, in the event that the worker were to be in danger of falling (e.g. the worker trips or stumbles, and is about to fall off of roof 16), his fall-prevention device would act as a brake. Meanwhile, the fall-prevention device is attached to device frame 26, which is in turn fastened to trailer body 12, with the result that the worker would be prevented from falling off of roof 16, and would be saved from the attendant injury.

Preferably, the ring 68 is positioned approximately midway along the length of device frame 26, and thus, approximately equidistant from the sides 18, 19 when the device frame 26 is fastened to the trailer body 12. This positioning is preferred because it maximizes the area of roof 16 that a worker can reach while his fall-prevention gear is attached to ring 68.

It will be appreciated that the attachment of the ring 68 to the frame 26 at opposed ends 38, 40, though preferred, is not required. Other modes of attachment are comprehended by the invention. The above-described form of attachment is preferred because it has been found that having two widely distributed attachment points distributes the force on those attachment points, and on the device frame 26, in a beneficial manner in the event that a worker is falling and is thus exerting a force on the device frame 26. By having the ring 68 attached to the frame 26 at the opposed ends 38, 40, the force on the frame 26 acts at points adjacent to the fastening points of the device frame 26 to the trailer body 12. Thus, the amount of twisting force and torque applied to the device frame 26 is reduced, thus reducing the risk that the device would not operate properly.

Furthermore, distributing the points at which the attachment means is attached to the device frame 26 is beneficial, in that it is less likely that the attachment means will undesirably come off of the device frame 26. For example, the invention comprehends the attachment means comprising a single eye-bolt at the center of device frame 26. However, in such a configuration, there is a greater risk that, in the event of a worker fall, such an eye-bolt would simply break off of device frame 26. Thus, in such a non-preferred configuration, it would be necessary to fix the eye-bolt to the center of device frame 26 very securely and carefully.

It will further be appreciated that the attachment means may take other forms besides the embodiments described above. What is important is that the attachment means be attached to the device frame and be configured and positioned to attach the fall-prevention device to the device frame.

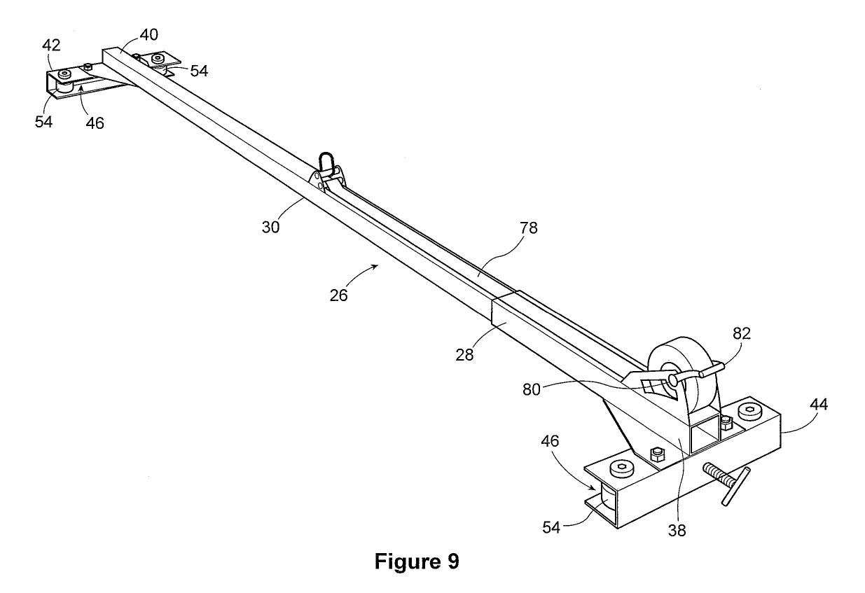

While the preferred embodiments have been described in detail, it will be appreciated that the invention comprehends other embodiments as well. For example, as shown at FIG. 9, the frame fastener may comprise a strap 78 attached to both frame elements, with the strap being attached to a release-and-retraction means, preferably in the form of spindle 80 and release element 82 for releasing spindle 80 to permit extension of the strap.

1. A worker safety device for use with an object having a person support surface, the device comprising:
a length-adjustable device frame positionable on said object;
a frame fastener coupled to the device frame configured to detachably fasten the device frame to the object;
an attachment means, attached to the device frame, configured and positioned to attach a personal fall-prevention device to the device frame;
whereby a person on said surface using the fall-prevention device can prevent a fall from said surface by attaching the fall-prevention device to the attachment means.

2. A worker safety device as claimed in claim 1, wherein the object has first and second sides extending downward from said surface, and wherein said device frame is positionable above the person support surface and the frame fastener is configured to fasten the device frame to the sides.

3. A worker safety device as claimed in claim 2, wherein the device includes two wheel means attached to the device frame and positioned such that one wheel means bears on each side, and such that said wheel means roll along said sides to facilitate movement of said device along said object.

4. A worker safety device as claimed in claim 2, wherein the frame fastener includes a first fastening element for fastening the device frame to one of the sides and a second fastening element for fastening the frame to the other side.

5. A worker safety device as claimed in claim 4, wherein said device frame has first and second opposed ends, the first fastening element being positioned at the first end, the second fastening element being positioned at the second end.

6. A worker safety device as claimed in claim 3, wherein the frame fastener includes a first fastening element for fastening the device frame to the first side and a second fastening element for fastening the device frame to the second side, and wherein each of the wheel means is associated with one of the fastening elements.

7. A worker safety device as claimed in claim 2, wherein the device frame has first and second opposed ends, and includes a first fastening element positioned at the first end for fastening the device frame to the first side, and a second fastening element positioned at the second end for fastening the device frame to the second side, the device further including a first low-friction slider associated with the first fastening element so as to slide along the first side to facilitate movement of the device along the object, and a second low friction slider associated with the second fastening element to as to slide along the second side to facilitate movement of the device along the object.

8. A worker safety device as claimed in claim 1, wherein the frame fastener comprises a grip force generator configured to generate a force causing the device frame to grip the object.

9. A worker safety device as claimed in claim 4, wherein the device frame comprises first and second elongate frame elements attached to one another, and slidably and axially movable relative to one another.

10. A worker safety device as claimed in claim 9, wherein the frame fastener is coupled to the frame elements and configured to move the frame elements relative to one another so as to position said fastening elements to fasten the device frame to the object.

11. A worker safety device as claimed in claim 10, wherein the frame fastener includes a rotatable threaded shaft coupled to the first and second frame elements.

12. A worker safety device as claimed in claim 11, wherein the shaft is threadably coupled to, and axially movable relative to, the first frame element, and attached to the second frame element.

13. A worker safety device as claimed in claim 12, wherein the frame fastener further includes a handle, attached to the shaft, for turning the shaft.

14. A worker safety device as claimed in claim 10, wherein said frame fastener comprises a tension spring attached to both frame elements, configured such that when the fastening elements are pulled apart, said spring applies a force to pull said fastening elements against the sides to grip the object.

15. A worker safety device as claimed in claim 10, wherein the frame fastener comprises a strap retractably attached to one of the frame elements and attached to the other frame element, and configured so that when the strap is retracted, the fastening elements are pulled against the sides to grip the object.

16. A worker safety device as claimed in claim 1, the attachment means comprising a hook-receiving element attached to the device frame.

17. A worker safety device as claims in claim 16, wherein the hook-receiving element comprises a ring.

18. A worker safety device as claimed in claim 17, wherein the ring is attached to both the first frame element and the second frame element adjacent the opposed ends of said device frame.

19. A worker safety device as claimed in claim 6, wherein the object comprises a truck trailer, the person support surface comprises a roof of said truck trailer, and wherein each of the sides includes a side rail running along the respective side adjacent the roof, the fastening elements being configured to fasten the device frame to the rails.

20. A method of preventing a worker from falling off of a roof of a truck trailer, the trailer having first and second side rails, the method comprising:
providing a worker safety device including a length-adjustable device frame, a first frame fastening element at a first end of the device frame, and a second frame fastening element at a second end of the device frame;
fastening the frame to the trailer by:
positioning the device frame in a pre-fastening position;
actuating a frame fastener to cause the frame fastening elements to fasten the device frame to the side rails;
attaching fall-preventing worker safety gear to the device to prevent a worker from falling.

21. A method as claimed in claim 20, wherein the actuating step comprises retracting a strap to pull the fastening elements together to fasten the device frame to the rails.

22. A method as claimed in claim 20, wherein the actuating step comprises pulling the device frame against the force of a spring, and then releasing the device frame to actuate the spring, wherein the spring urges the fastening elements to bear against and grip the rails.

23. A method as claimed in claim 20, wherein the attaching step includes attaching a safety harness worn by a worker to the worker safety device.

24. A method as claimed in claim 20, wherein the actuating step comprises rotating a threaded shaft coupled to both fastening elements so as to cause the fastening elements to fasten the frame to the rails.
